(19) United States
(12) Patent Application Publication
(10) Pub. No.: US 2015/0031432 A1
(43) Pub. Date: Jan. 29, 2015

(54) BEST HAND VIDEO POKER

(71) Applicant: John M. Morrash, Pipersville, PA (US)

(72) Inventor: John M. Morrash, Pipersville, PA (US)

(21) Appl. No.: 14/338,068

(22) Filed: Jul. 22, 2014

Related U.S. Application Data
(60) Provisional application No. 61/857,508, filed on Jul. 23, 2013.

(51) Int. Cl. G07F 17/32

(52) U.S. Cl. CPC G07F 17/3293; G07F 17/3262
USPC 463/13

(57) ABSTRACT

The electronic best hand poker game of the present invention provides an electronic poker game with a variation of five card draw poker that challenges players to achieve a best hand from a series of specially configured draws capable of being played on gaming devices and also downloadable to smart phones, cell phones and personal computers and electronic devices and further wherein cards are presented in a three row pyramid, wherein the pyramid permits the presentation of twelve cards displaying six cards in a bottom row, four cards in a middle row and two cards in a top row, and further wherein the pyramid of twelve card spaces is filled progressively by a player's selections from three draws of seven cards, and the player is challenged to form his best five card poker hand.

### CLAIM OF PRIORITY

This patent application claims priority under 35 USC 119 (e) (1) from U.S. Provisional Patent Application Ser. No. 61/857,508 filed Jul. 23, 2013, of common inventorship herewith entitled, “Best Hand Poker.”

### FIELD OF THE INVENTION

The present invention pertains to the field of games, and more specifically to the field of poker card games, and even more specifically to the field of video poker games.

### BACKGROUND OF THE INVENTION

The prior art has put forth several designs for poker card games. Among these are:

U.S. Pat. No. 7,785,182 to Dion K. Aoki, Jeremy M. Hornik and Alfred Thomas describes a method of playing a card based wagering game. The method comprises conducting the card based wagering game at a gaming terminal and displaying a plurality of cards arranged in an array. The plurality of cards includes a first set of selectable cards and a first set of non selectable cards. The non selectable cards are at least partially protected by others of the plurality of cards. One or more of the selectable cards are selected. A player's hand is created by removing the selected cards from the array, which then creates a second set of selectable cards and a second set of non selectable cards in the array such that the second set of non selectable cards are at least partially protected by others of the plurality of cards. It is then determined whether the player's hand is a winning hand.

U.S. Pat. No. 6,817,615 to Thomas M. Dacey describes a method for playing a poker card game is disclosed which relates to a modified poker card game utilizing playing cards arranged in a pyramid like format from which, in addition to forming a winning hand from cards in the deck as dealt, also utilizes the pyramid card arrangement from which a winning poker hand may be combined with the deck dealt cards.

U.S. Pat. No. 5,486,005 to Michael D. Neal describes a method and apparatus for playing a poker like game with a deck of fifty two playing cards wherein each player plays against the dealer. After each player makes a wager, the dealer deals four initial cards of the deck face up to seven separate hands, places odds on each hand according to predetermined guidelines, and selects two of the seven hands as a combination field position. Each player then selects either one of the hands, the field position, or a no hand winning position which requires that none of the seven hands, after all cards are dealt, have two pairs or better. After each player selects a hand or a position, the dealer deals three more cards of the deck face up to each of the seven separate hands. The dealer then determines the winning hand or position and pays each player who selected the winning hand or position according to the odds and their wager or collects each player's wager who did not select the winning hand or position. Additionally, a jackpot wheel is included to permit an added possibility of winning a larger payout.

None of these prior art references describe the present invention.

Whether meeting and playing a spirited round of Go Fish with a best friend or trying to defeat a blackjack champion, the excitement and camaraderie engendered by a good card game makes such an event eagerly anticipated and richly enjoyed. Group card games are extremely popular in inspiring recreational fun. From children sitting cross legged on a recreational room floor to a group of retirees gathered around a table, games such as gin rummy and bridge engender a competitive spirit that crosses generational lines. It is common for groups of friends all across the country to gather for a weekly poker game. Poker is the most popular of a class of games called vying games in which players with fully or partially concealed cards make wagers into a central pot, after which the pot is awarded to the remaining player or players with the best combination of cards. Upon its development in the mid nineteenth century, poker struck a chord with thrill seeking game players, and this love of the game continues unabated.

### SUMMARY OF THE INVENTION

It is an object of the present invention to provide an electronic poker game with a variation of five card draw poker that challenges players to achieve a best hand from a series of specially configured draws.

### BRIEF DESCRIPTION OF THE DRAWINGS

FIGS. 1 through 14 show prototypical progressive display screens in accordance with the present invention.

### DETAILED DESCRIPTION OF THE INVENTION

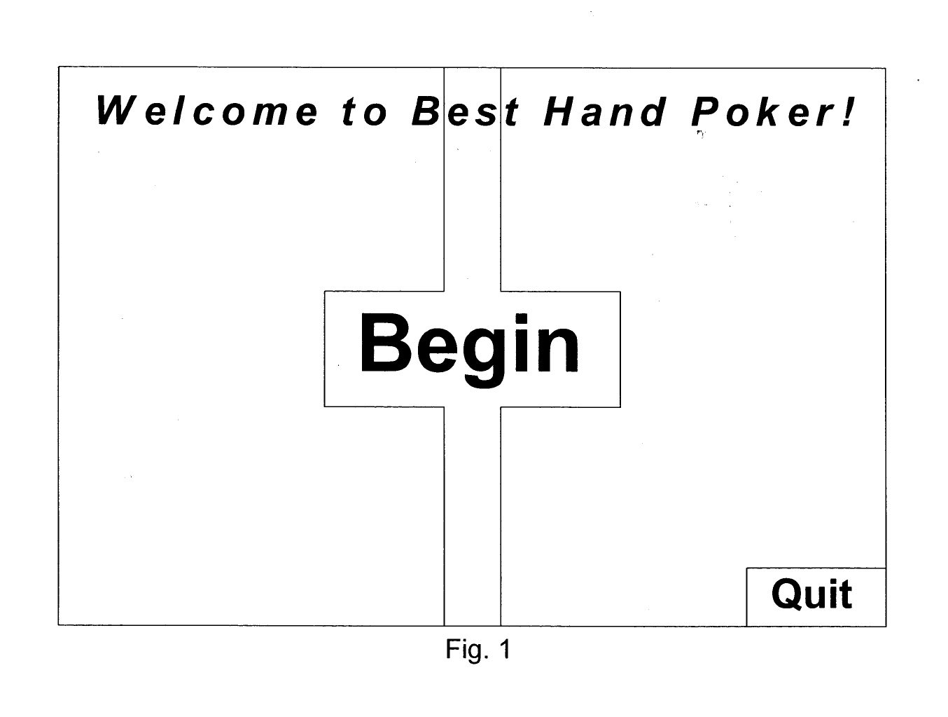

FIG. 1 is a prototypical illustrative view of a first progressive screen display which welcomes the player, and prompts the player with a button in the center of the screen to begin game play.

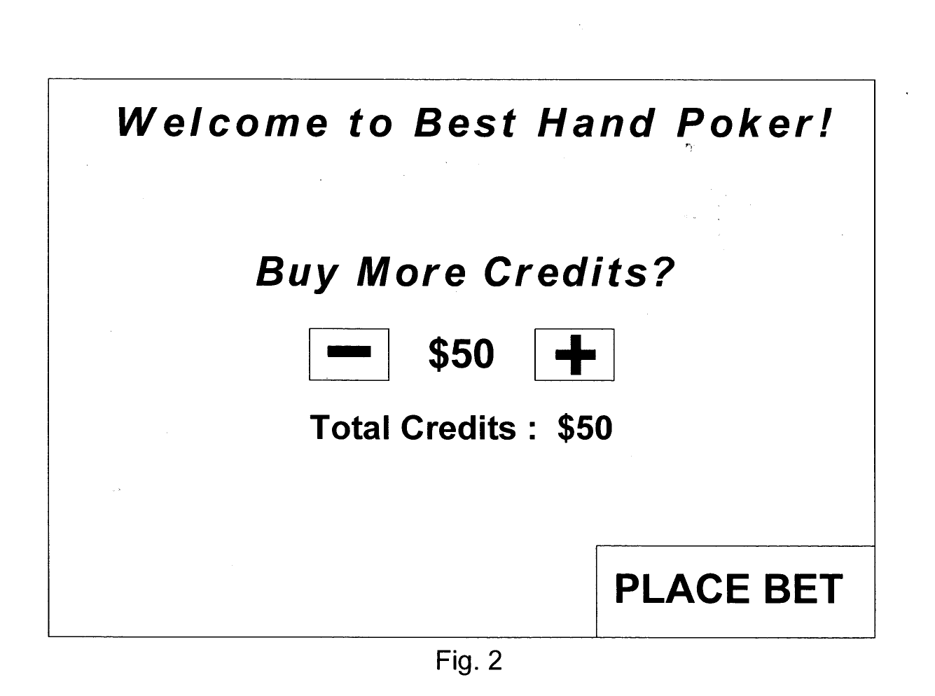

FIG. 2 is a prototypical illustrative view of a second progressive screen display which allows the player to purchase game credits to be for in-game bets.

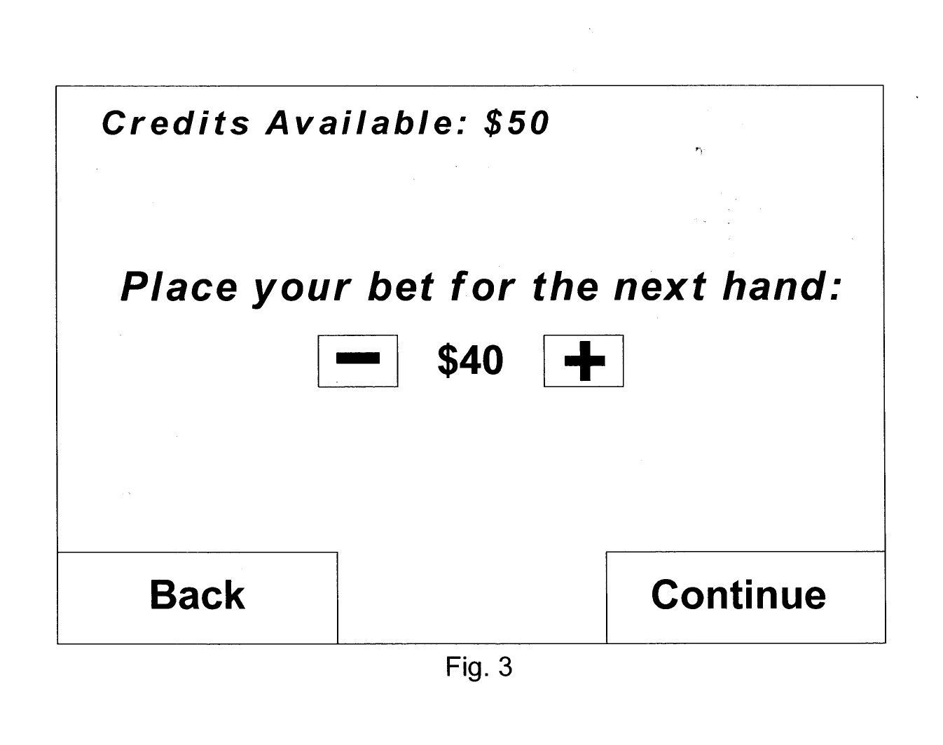

FIG. 3 is a prototypical illustrative view of a third progressive screen display which allows the player to place a bet based on how many in-game credits the player has available.

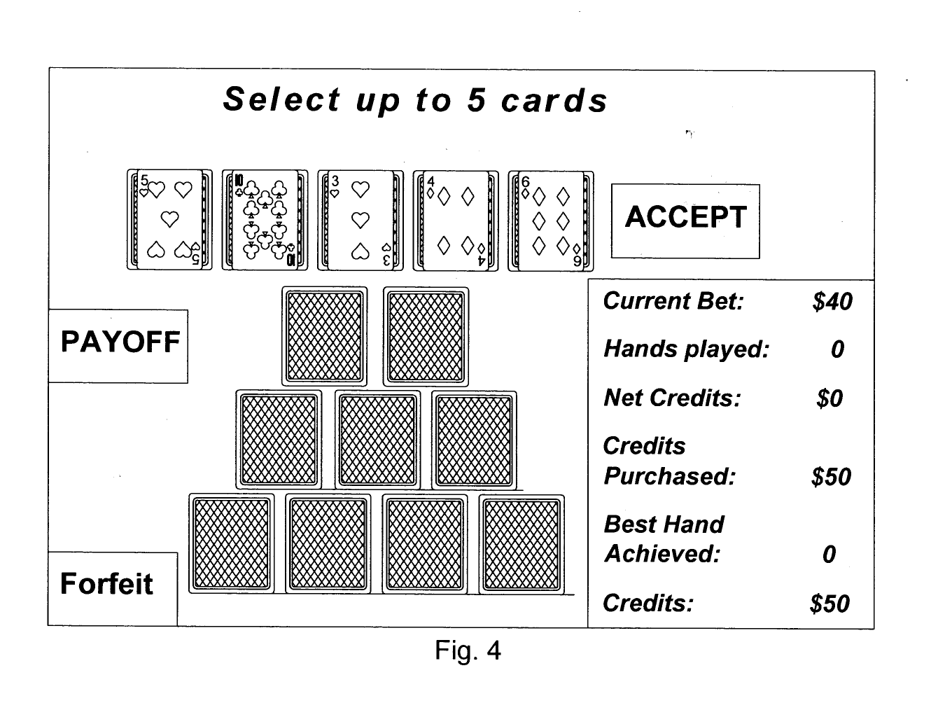

FIG. 4 is a prototypical illustrative view of a fourth progressive screen display which shows a pyramid consisting of nine cards. Five randomly drawn cards are shown above the pyramid, with instructions to select cards to place in the pyramid.

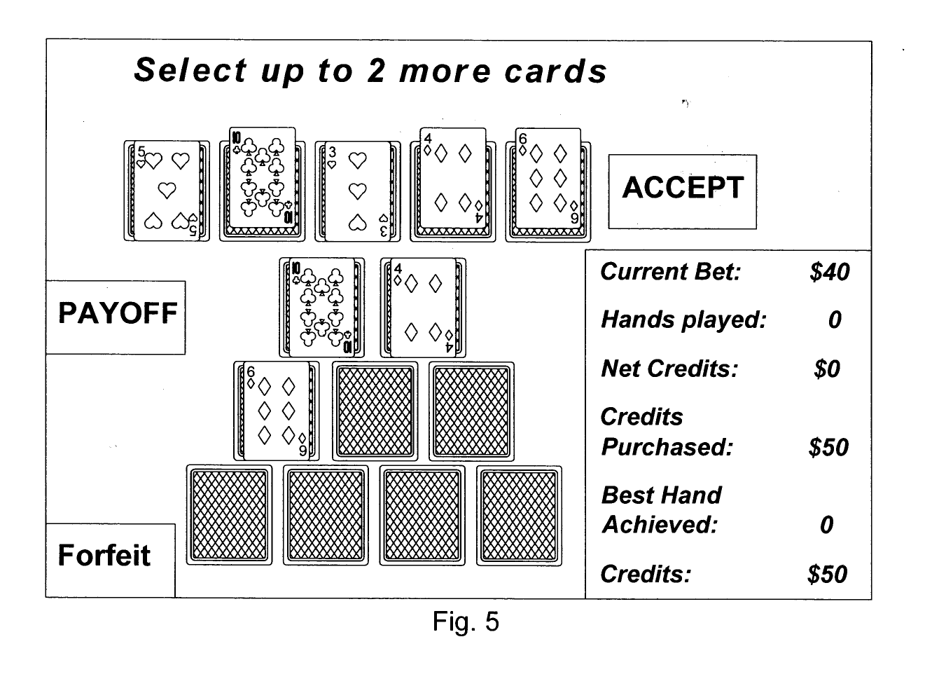

FIG. 5 is a prototypical illustrative view of a fifth progressive screen display showing cards selected from the first deal.

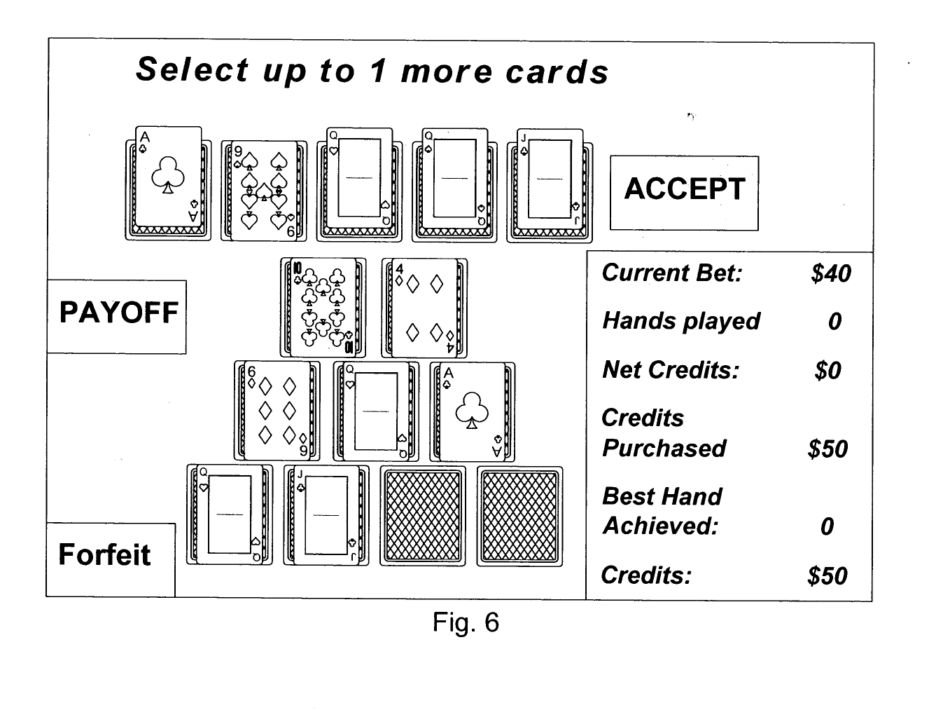

FIG. 6 is a prototypical illustrative view of a sixth progressive screen display which shows the second deal of five randomly drawn cards, instructions to select cards to place in the pyramid, and cards selected from the second draw.

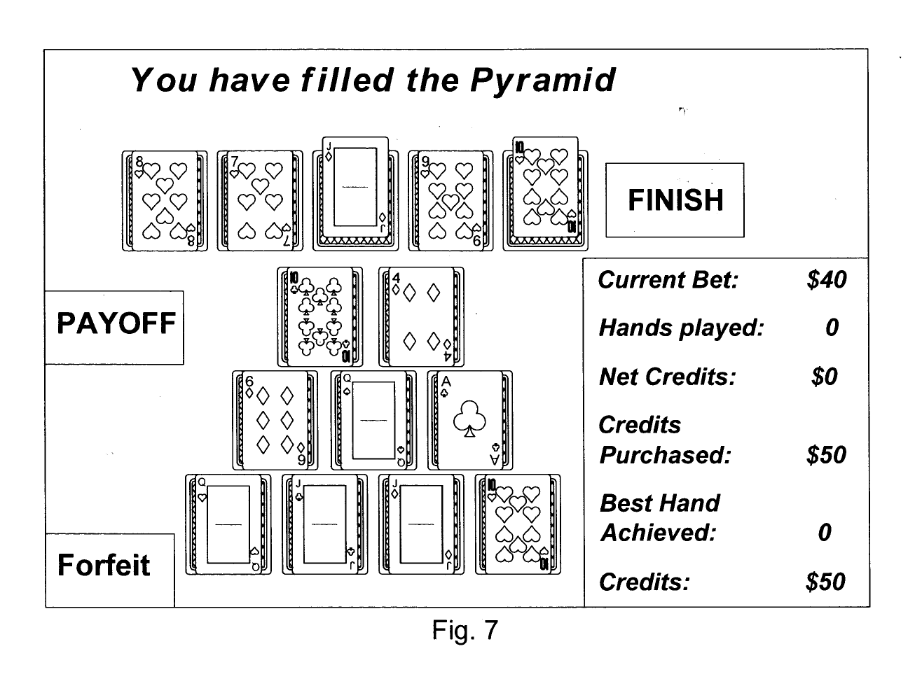

FIG. 7 is a prototypical illustrative view of a seventh progressive screen display showing the third deal of five randomly drawn cards, and cards selected form the third draw to fill the pyramid.

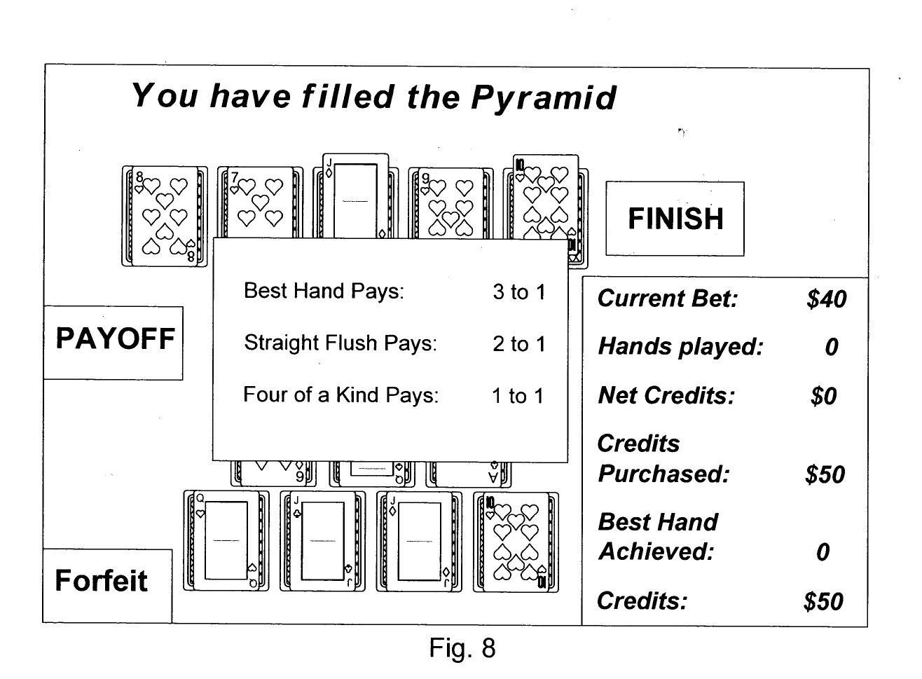

FIG. 8 is a prototypical illustrative view of an eighth progressive screen display showing the credit payoff information for the high-ranking hands.

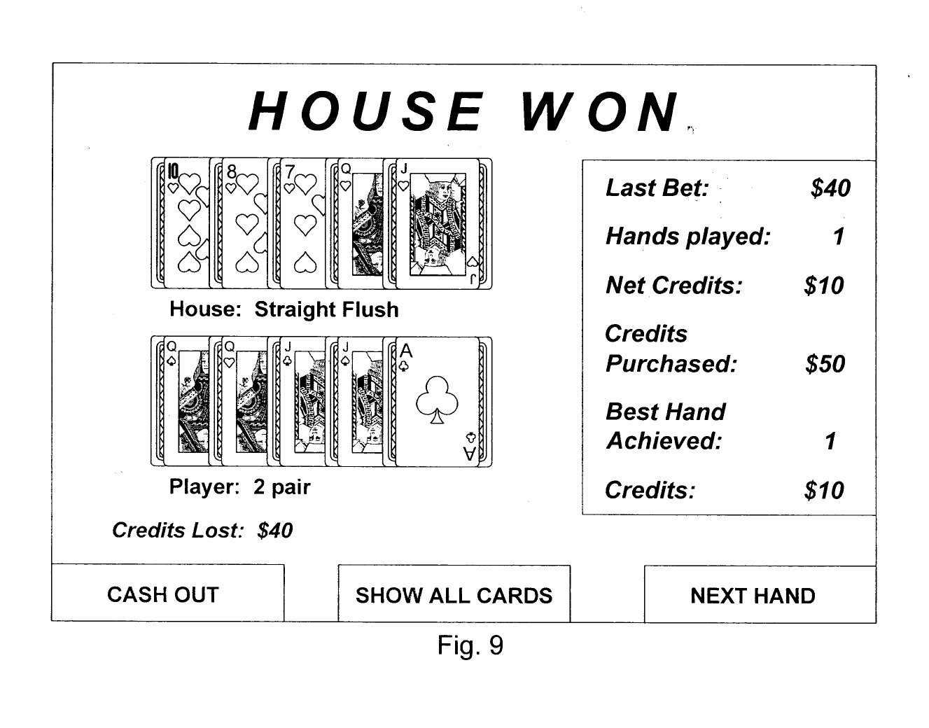

FIG. 9 is a prototypical illustrative view of a ninth progressive screen display showing the house is the winner. Displayed are the player's best hand and house's best hand along with all the player's game statistics.

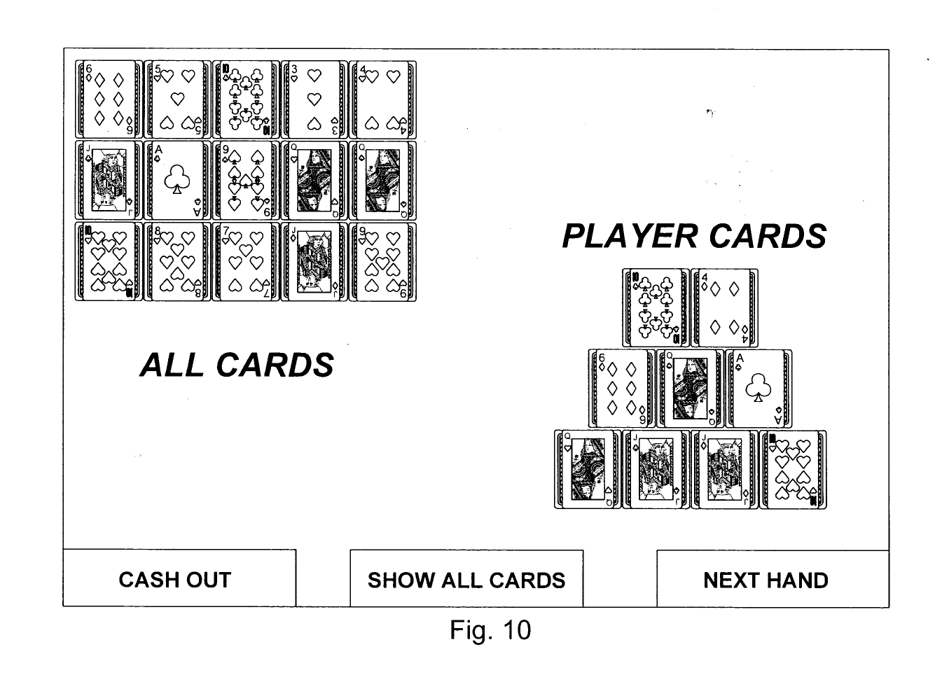

FIG. 10 is a prototypical illustrative view of a tenth progressive screen display showing a post-game screen that shows all cards dealt during the game as well as the cards chosen by the player during each round.

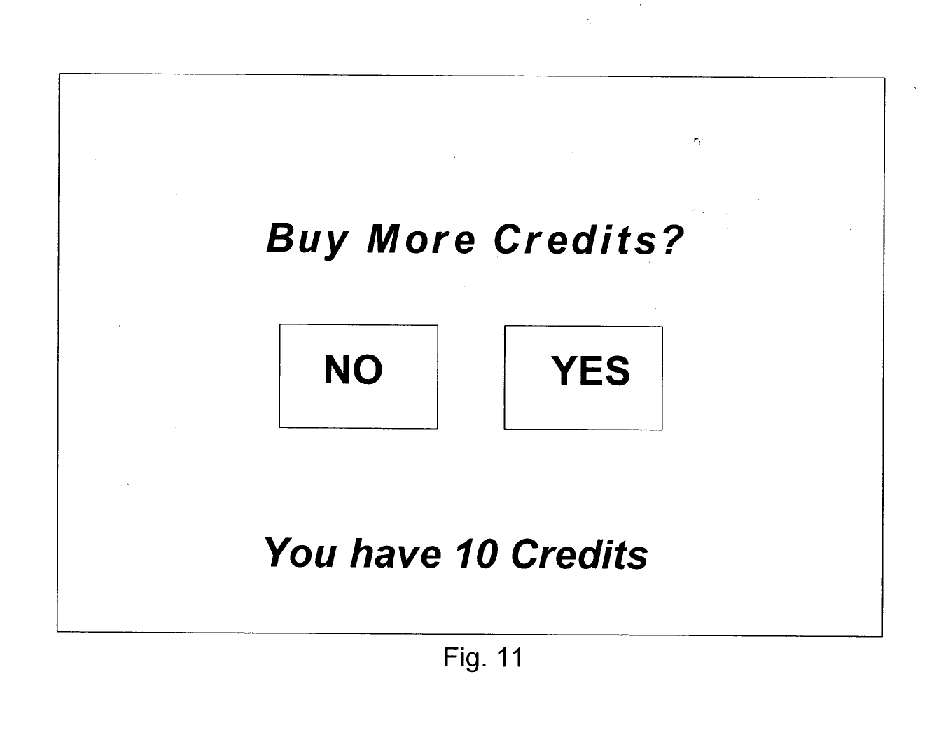

FIG. 11 is a prototypical illustrative view of an eleventh progressive screen display asking if the player would like to purchase additional credits in between rounds.

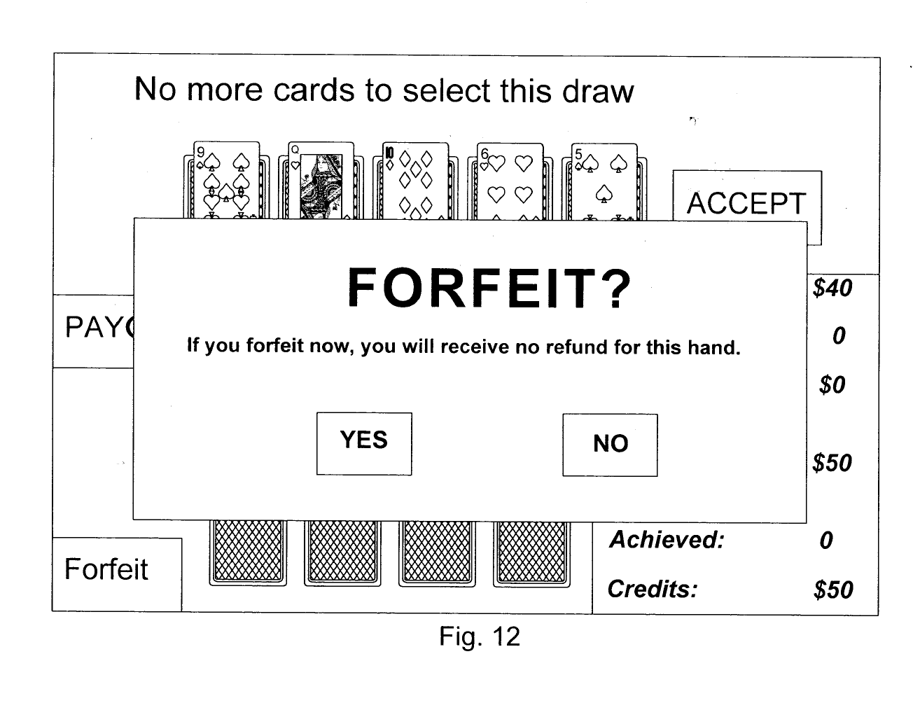

FIG. 12 is a prototypical illustrative view of a twelfth progressive screen that the player can access, should they choose to forfeit the match.

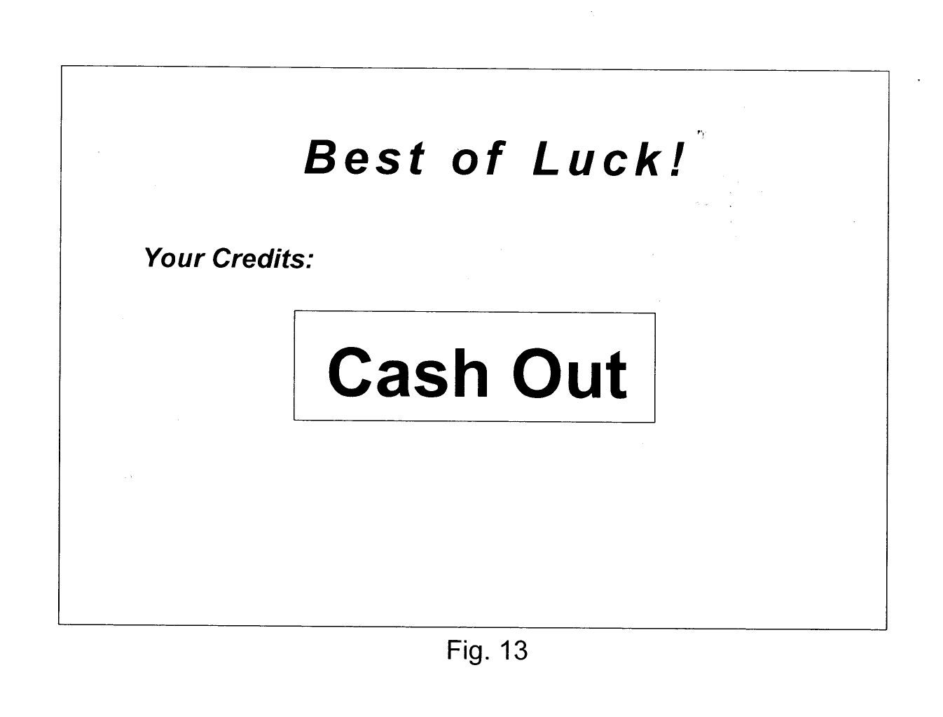

FIG. 13 is a prototypical illustrative view of a thirteenth progressive screen display showing the last game screen where the player can view their winnings and cash out.

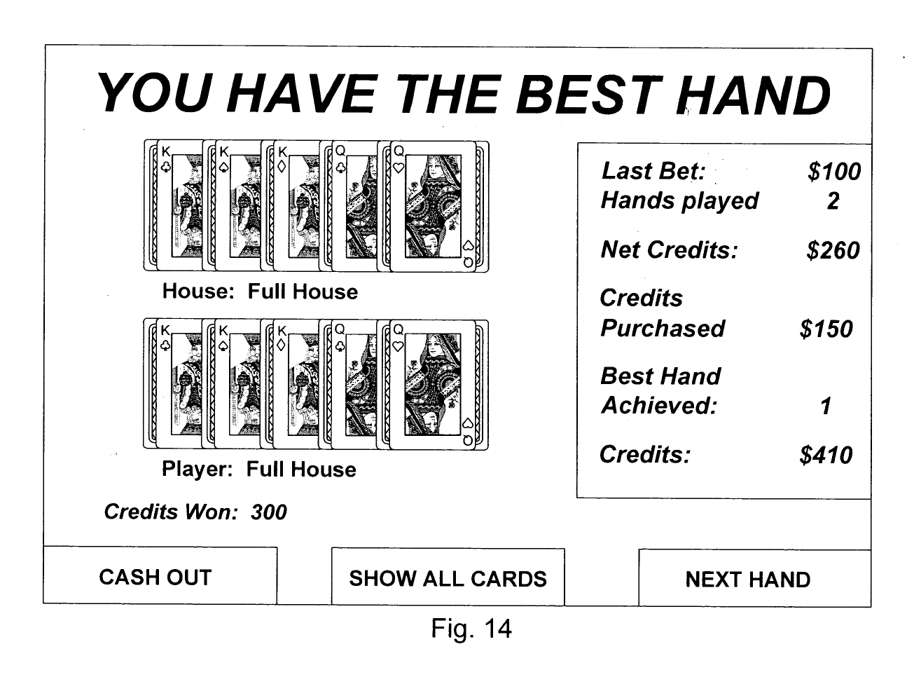

FIG. 14 is a prototypical illustrative view of a fourteenth progressive screen display showing a post-game screen declaring the player as the winner. Displayed are the player's best hand and the house's best hand, along with the player's game statistics.

The present invention, hereinafter referred to as the Best Hand Video Poker, or Best Hand Poker, is an electronic card game with a variation to five card draw poker that helps players achieve their best hand from a series of specially configured draws. Best Hand Poker provides poker aficionados with a unique new way to play the popular game of poker. Best Hand Poker is a specially augmented poker game based on five card draw that allows players to achieve better odds against the house and obtain the best hand. The object of Best Hand Poker is to make the best possible five card poker hand from a series of three draws of seven cards. This game utilizes basic rules common to five card draw poker and is played with a standard deck of approximately fifty two playing cards. Cards are presented in a three row pyramid. This configuration permits the presentation of twelve cards displaying six cards in a bottom row, four cards in a middle row and two cards in a top row. This pyramid of twelve card spaces is filled progressively by a player's selections from three draws of seven cards. Once the pyramid is complete with the twelve cards selected by the player, the player is challenged to form his best five card poker hand. The house's best hand then is selected from twenty one cards drawn during the game and compared to the player's best hand to determine the winner of the poker game.

The following is a summary of the Best Hand Poker draws which display in fourteen separate screen views showing an electronic simile of the card pyramids in each move. The first screen view shows seven cards randomly drawn for the first row.

The player then selects two cards from this draw and places them in the pyramid. This placement becomes the second screen view. The third screen view displays a second draw where seven cards are shown forming a top row of the pyramid. The fourth screen view is constituted of a first row showing the two cards from the player's first draw and second row showing the four cards selected by the player in the second drawing. The fifth screen view displays seven new random cards on a top row of the pyramid, a second row shows two cards from the player's first draw and a third row showing the four cards selected by the player in the second drawing. From all cards in this fifth screen view, the player selects six cards and places these in the pyramid to form the sixth screen view. From this sixth screen view, which displays twelve cards selected from all three draws, the player selects his best hand. The seventh view displays the player's selections showing his best hand. The eighth view shows all cards drawn in the game from which the house selects its best hand. The ninth view heralds the best house hand selected from all cards drawn in the game and also displays the winner of the game. The tenth progressive screen display shows a post-game screen that shows all cards dealt during the game as well as the cards chosen by the player during each round. The eleventh progressive screen display asks if the player would like to purchase additional credits in between rounds. The twelfth progressive screen that the player can access, gives the player the option to forfeit the match. The thirteenth progressive screen display shows the last game screen where the player can view their winnings and cash out. The fourteenth progressive screen display shows a post-game screen declaring the player as the winner. Displayed are the player's best hand and the house's best hand, along with the player's game statistics.

Best Hand Poker provides poker playing enthusiasts with hours of competitive and challenging fun. Increasing the thrills of a poker game by offering a cleverly designed combination of suits, the Best Hand Poker enables players to delight in making smart bets against a chancy yet often times more successful draw of cards. Best Hand Poker is versatile and a game that is playable virtually anywhere. For home play, Best Hand Poker is developed for gaming devices and also downloadable to smart phones, cell phones and personal computers and electronic devices. The Best Hand Poker concept also brings an exciting new game to public and private casinos, appealing to both savvy gamblers and novices who wish to play a simple game of chance.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An electronic poker game comprising a variation of five card draw poker that challenges a player to achieve a best hand from a series of specially configured draws, wherein the object of the game is to make the best possible five card poker hand from a series of three draws of seven cards, wherein the game utilizes basic rules common to five card draw poker and is played with a standard deck of approximately fifty two playing cards, and further wherein cards are presented in a three row pyramid, wherein the pyramid configuration permits the presentation of twelve cards displaying six cards in a bottom row, four cards in a middle row and two cards in a top row, and further wherein the pyramid of twelve card spaces is filled progressively by a player's selections from three draws of seven cards, and further wherein when the pyramid is complete with twelve cards selected by the player, the player is challenged to form his best five card poker hand; and further wherein a house's best hand then is selected from twenty one cards drawn during the game and compared to the player's best hand to determine the winner of the poker game.

2. The electronic poker game of claim 1, wherein the game is suitable for home play, and is capable of being played on gaming devices and also downloadable to smart phones, cell phones and personal computers and electronic devices.

3. The electronic poker game of claim 1, wherein the game comprises a series of nine consecutive display screen views comprising:
a first screen view showing seven cards randomly drawn for the first row, after which the player then selects two cards from this draw and places them in the pyramid, wherein the placement of these two selected cards becomes the second screen view, wherein the third screen view displays a second draw where seven cards are shown forming a top row of the pyramid, wherein the fourth screen view comprises a first row showing the two cards from the player's first draw and second row showing the four cards selected by the player in the second drawing, and wherein the fifth screen view displays seven new random cards on a top row of the pyramid, a second row shows two cards from the player's first draw and a third row showing the four cards selected by the player in the second drawing, further wherein the player selects six cards from all cards in the fifth screen view and places these in the pyramid to form the sixth screen view, and further wherein the player selects his best hand from this sixth screen view, which displays twelve cards selected from all three draws, and wherein the seventh screen view displays the player's selections showing his best hand, further wherein the eighth view shows all cards drawn in the game from which the house selects its best hand, and wherein the ninth screen view heralds the best house hand selected from all cards drawn in the game and also displays the winner of the game.

4. The electronic poker game of claim 1, wherein the game comprises a series of fourteen consecutive display screen views comprising:
a first screen view showing seven cards randomly drawn for the first row, after which the player then selects two cards from this draw and places them in the pyramid, wherein the placement of these two selected cards becomes the second screen view, wherein the third screen view displays a second draw where seven cards are shown forming a top row of the pyramid, wherein the fourth screen view comprises a first row showing the two cards from the player's first draw and second row showing the four cards selected by the player in the second drawing, and wherein the fifth screen view displays seven new random cards on a top row of the pyramid, a second row shows two cards from the player's first draw and a third row showing the four cards selected by the player in the second drawing, further wherein the player selects six cards from all cards in the fifth screen view and places these in the pyramid to form the sixth screen view, and further wherein the player selects his best hand from this sixth screen view, which displays twelve cards selected from all three draws, and wherein the seventh screen view displays the player's selections showing his best hand, further wherein the eighth view shows all cards drawn in the game from which the house selects its best hand, and wherein the ninth screen view heralds the best house hand selected from all cards drawn in the game and also displays the winner of the game, and further wherein the tenth screen view shows a post-game screen that shows all cards dealt during the game as well as the cards chosen by the player during each round, and further wherein the eleventh progressive screen display asks if the player would like to purchase additional credits in between rounds, and further wherein the twelfth screen view gives the player the option to forfeit the match, and further wherein the thirteenth screen view shows the last game screen where the player can view their winnings and cash out, and further wherein the fourteenth progressive screen view shows a post-game screen declaring the player as the winner, where the player's best hand and the house's best hand, along with the player's game statistics are displayed.

5. The electronic poker game of claim 1, wherein the game is capable of being played on gaming devices.

6. The electronic poker game of claim 3, wherein the game is suitable for home play, and is capable of being played on gaming devices and also downloadable to smart phones, cell phones and personal computers and electronic devices.

7. The electronic poker game of claim 4, wherein the game is suitable for home play, and is capable of being played on gaming devices and also downloadable to smart phones, cell phones and personal computers and electronic devices.
